(19) United States
(12) Patent Application Publication
(10) Pub. No.: US 2015/0099032 A1
(43) Pub. Date: Apr. 9, 2015

(54) NUTRITIONAL COMPOSITIONS AND METHODS

(71) Applicant: Vitathlete, Vitaman LLC, Naples, FL (US)

(72) Inventors: Christopher Roumayeh, Naples, FL (US); Shawn Bellestri, Naples, FL (US); Jonas Christopher Jerebko, Oakland Township, MI (US)

(21) Appl. No.: 14/091,648

(22) Filed: Nov. 27, 2013

Related U.S. Application Data
(60) Provisional application No. 61/888,326, filed on Oct. 8, 2013.

(51) Int. Cl. A23L 1/30; A23L 1/305

(52) U.S. Cl. CPC A23L 1/3002; A23L 1/3051; A23V 2002/00
USPC 426/2; 426/648; 426/72

(57) ABSTRACT

Nutritional compositions comprising a botanical component, such as adaptogenic botanical component, comprising one or more ginsenosides and an amino acid component. Botanical components include ginsenosides, such as a Panax extract (e.g., a Panax notoginseng extract), an Astragalus extract (e.g., an Astragalus membranaceus extract), a Rosa extract (e.g., a Rosa roxburghii extract), fractions thereof, active components thereof, and combinations thereof. Amino acid components may include isoleucine, leucine, lysine, methionine, phenylalanine, threonine, tryptophan, valine, or combinations thereof. Also disclosed are methods for improving the metabolism of a human or other mammalian subject, comprising administering a composition of the present technology. Such methods include those for improving the nutritional status of the subject, improving nutrient absorption of the subject, improving physical performance of the subject, and improving glycogen metabolism of the subject.

### CROSS-REFERENCE TO RELATED APPLICATIONS

This application claims the benefit of U.S. Provisional Application No. 61/888,326, filed on Oct. 8, 2013. The entire disclosure of the above application is incorporated herein by reference.

### INTRODUCTION

The present technology relates to nutritional compositions and methods comprising botanical and amino acids.

The art is replete with compositions containing any of a variety of materials that are said to improve the nutritional status or provide other health benefits for humans and other mammals. Such materials include vitamins, minerals, amino acids, botanicals, and other materials that may provide a nutritional or other health benefit.

Some compositions are also said to enhance physical performance or provide other health benefits during sports or other exercise. Significant changes may occur in muscle tissue during exercise, which can result in muscle fatigue and other metabolic changes that affect physical performance. Such nutritional supplements may provide nutrients that are helpful in mediating these changes. However, the nutrients in these formulations may not be bioavailable or may not have a significant impact on performance. Moreover, some compositions may even present potential side effects. Accordingly, there remains a need for compositions that provide meaningful nutritional benefits for humans or other animals, particularly for subjects that are participating in sports or other physical exercise.

### SUMMARY

The present technology provides nutritional compositions comprising a botanical component, such as adaptogenic botanical component, comprising one or more ginsenosides and an amino acid component. In various embodiments, botanical components include ginsenosides, such as a Panax extract (e.g., a Panax notoginseng extract), an Astragalus extract (e.g., an Astragalus membranaceus extract), a Rosa extract (e.g., a Rosa roxburghii extract), fractions thereof, active components thereof, and combinations thereof. Amino acid components may include isoleucine, leucine, lysine, methionine, phenylalanine, threonine, tryptophan, valine, or combinations thereof.

The present technology also provides methods for improving the metabolism of a human or other mammalian subject, comprising administering a composition of the present technology. Such methods include those for improving the nutritional status of the subject, improving nutrient absorption of the subject, improving physical performance of the subject, and improving glycogen metabolism of the subject.

### DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Description.

### Compositions

The present technology provides nutritional compositions, such as for improving the nutritional or metabolic status of a human or other mammal. The compositions comprise one or more nutritionally-acceptable botanical components and one or more amino acids. Such “nutritionally-acceptable” components provide a nutritional benefit, without undue adverse side effects (such as toxicity, irritation, or allergic response), commensurate with a reasonable benefit/risk ratio when used in the manner of this technology.

### Botanical Component

The present compositions comprise an adaptogenic botanical component. Adaptogens among those useful herein include plant extracts effective to normalize or otherwise mediate metabolic processes in a human or other mammalian, so as to increase the ability of the subject to adapt to stress or other environmental factors. Such factors include exercise-induced oxidative stress. Adaptogens include botanicals selected from the group consisting of American ginseng, ashwagandha (Withania somnifera), Asian ginseng, astragalus, codonopsis root (Dang Shen), cordyceps, echinacea, goji (Lycium barbarum), eleuthero root (Siberian ginseng), jiaogulan, licorice root (Glycyrrhiza glabra), Mahonia aquifolium, Populus tremuloides, reishi mushrooms (Ganoderma lucidum), pana ginseng, schizandra, Rhodiola rosea, tulsi (holy basil), fractions thereof, active components thereof, and combinations thereof.

In various embodiments, compositions of the present technology comprise a botanical component selected from the group consisting of a Panax extract (e.g., a Panax notoginseng extract), an Astragalus extract (e.g., an Astragalus membranaceus extract), a Rosa extract (e.g., a Rosa roxburghii extract), fractions thereof, active components thereof, and combinations thereof. In some embodiments, a botanical component comprises a Panax notoginseng extract, an Astragalus membranaceus extract, and a Rosa roxburghii extract. In various embodiments, compositions comprise an additional adaptogenic botanical (i.e., a botanical in addition to a botanical selected from the group consisting of a Panax extract, an Astragalus extract, a Rosa extract, fractions thereof, active components thereof, and combinations thereof). Such additional adaptogenic botanicals include American ginseng, ashwagandha (Withania somnifera), Asian ginseng, codonopsis root (Dang Shen), cordyceps, echinacea, goji (Lycium barbarum), eleuthero root (Siberian ginseng), jiaogulan, licorice root (Glycyrrhiza glabra), Mahonia aquifolium, Populus tremuloides, reishi Mushrooms (Ganoderma lucidum), schizandra, Rhodiola rosea, tulsi (holy basil), fractions thereof, active components thereof, and combinations thereof.

The compositions of the present technology preferably comprise a Panax extract, i.e., an extract from the plant material (e.g., the leaf or root) of a plant of the genus Panax. Such plants include P. bipinnatifidus, P. ginseng, P. notoginseng, P japonicus, P. quinquefolius, P. vietnamensis, P. wangianus, P. zingiberensis, P. pseudoginseng, P. stipulenatus, and P. trifolius. Preferably, the Panax extract is from the root of Panax notoginseng.

Botanical extracts may be made by any method suitable for making pharmaceutical or nutritional materials for human or mammalian consumption, including methods among those known in the art. Such methods may generally comprise treatment of plant material with one or more suitable solvents (such as water or ethanol) to produce a botanical extract, followed by fractionation to produce one or more compounds or mixtures of compounds.

An extract of P. notoginseng may be made by methods among those known in the art. Such extracts comprise dammarane saponins, including ginsenosides Rb1, Rd, Re, and Rg1.1. In some embodiments, a P. notoginseng root extract may contain from about 0.05 to about 4%, by weight, of ginsenoside Rb1, by weight. P. notoginseng extracts among those useful herein are described in U.S. Patent Application Publication 2006/0293255, Lin et al., published Dec. 28, 2006, and U.S. Patent Application Publication 2009/0181904, Lin et al., published Jul. 16, 2009.

The compositions of the present technology preferably comprise an Astragalus extract, i.e., an extract from the plant material (e.g., the root) of a plant of the genus Astragalus. Such plants included P. propinquus and P. membranaceus. Preferably the Astragalus extract is from the root of Astragalus membranaceus.

An extract of Astragalus membranaceus may be made by methods among those known in the art. In some embodiments, an A. membranaceus extract comprises saponins, flavonoids, polysaccharides, amino acids and trace elements, including cycloartane triterpene glycosides (astragalosides I-V). Preferably the A. membranaceus extract comprises at least about 0.005% by weight of astragaloside I. A. membranaceus extracts among those useful herein are described in U.S. Patent Application Publication 2012/0196816, Lin et al., published Aug. 2, 2012, and U.S. Patent Application Publication 2012/0196817, Lin et al., published Aug. 2, 2012.

In some embodiments, the present composition comprises a mixture of Panax notoginseng and Astragalus membranaceus extracts. One such extract is commercially available as AstraGin™, from NuLiv Science USA, Inc. (Walnut, Calif., USA). Such extracts comprise at least about 1.5% total saponins, at least about 0.01% astragaloside I, and at least about 0.1% ginsenoside Rb1. In some embodiments, a unit composition of the present technology may comprise from about 10 mg to about 100 mg, or from about 20 mg to about 70 mg, of AstraGin™. (As referred to herein, a “unit composition” contains a botanical component and amino acid in amounts that are suitable for oral administration to an intended human or mammalian subject, in a single bolus composition.)

The compositions of the present technology preferably comprise a Rosa extract, preferably an extract from the fruit of Rosa roxburghii. R. roxburghii extracts among those useful herein may comprise flavonoids, phenol antioxidants, Vitamin C, Vitamin A, Vitamin B₁, Vitamin B₂, Vitamin D, and Vitamin E. Such extracts are commercially available, such as RosaEx™, sold by NuLiv Science USA, Inc. (Walnut, Calif., USA). Compositions of the present technology may comprise mixtures of a Rosa roxburghii extract with other botanicals, such as ActiGin™, sold by NuLiv Science USA, Inc. (Walnut, Calif., USA), which contains a mixture of R. roxburghii extract with a Panax notoginseng extract. For example, a unit composition of the present technology may comprise from about 10 mg to about 100 mg, or from about 20 mg to about 70 mg, of ActiGin™.

### Amino Acid Component

The compositions of the present technology also comprise one or more amino acids. The amino acids may be present in elemental form, i.e., as substantially pure amino acids, or salts thereof, preferably comprising elemental L-amino acids. In some embodiments, however, an amino acid component may comprise peptides or proteins comprising two, three, four, or more amino acids.

Preferably, the amino acid component comprises amino acids, preferably elemental amino acids, selected from the group consisting of isoleucine, leucine, lysine, methionine, phenylalanine, threonine, tryptophan, valine, and combinations thereof. For example, a unit composition may comprise from about 500 mg to about 5,000 mg, from about 800 mg to about 2000 mg, or about 1000 mg to about 1800 mg, of L-isoleucine. A unit composition may comprise from about 500 mg to about 5,000 mg, from about 1000 mg to about 2,500 mg, or about 1,500 mg to about 2,000 mg, of L-leucine. A unit composition may comprise from about 500 mg to about 5,000 mg, from about 1000 mg to about 2,500 mg, or about 1,500 mg to about 2,000 mg, of L-lysine. A unit composition may comprise from about 100 mg to about 1,000 mg, from about 200 mg to about 800, or about 400 mg to about 700 mg, of L-methionine. A unit composition may comprise from about 400 mg to about 5,000 mg, from about 800 mg to about 2000, or about 1000 to about 1500 mg, of L-phenylalanine. A unit composition may comprise from about 400 mg to about 4,000 mg, from about 500 mg to about 1800 mg, or about 800 mg to about 1200 mg, of L-threonine. A unit composition may comprise from about 100 mg to about 1,000 mg, from about 150 mg to about 600 mg, or about 200 mg to about 500 mg, of L-tryptophan. A unit composition may comprise from about 500 mg to about 5,000 mg, from about 1000 mg to about 2,500 mg, or about 1,400 mg to about 1,900 mg, of L-lysine.

Compositions of the present technology may comprise two or more, three or more, or four or more of the amino acids described above. In some embodiments, compositions comprise isoleucine, leucine, lysine, methionine, phenylalanine, threonine, tryptophan, and valine. Compositions comprising amino acids and combinations thereof useful herein are disclosed in U.S. Pat. No. 5,132,113, Luca, issued Jul. 21, 1992.

### Formulations

The compositions of the present technology may be provided in any form suitable for oral consumption by a human or other mammal. For example, such formulations may be tablets, capsules, powders, and liquids. Compositions may be provided in unit dosage form, comprising an amount of a botanical component and an amount of an amino acid component suitable for ingestion by a human or mammalian subject in a single dose. One such unit dosage is a “shot” product consisting of a powder which may be dissolved in about 4 ounces of water, for consumption as a single serving beverage.

Compositions may contain optional components, such as optional nutritional components, flavorants, sweeteners (such as stevia leaf extract), colorants, dissolution aids (for powder compositions), preservatives, and mixtures thereof. Optional nutritional components include materials that provide nutritional or physiological benefits. For example, the compositions may optionally comprise electrolytes which can affect the amount of water in the body, the acidity of blood (pH), cardiac and other muscle function, nerve activity, blood pressure, and other physiological processes. Electrolytes include calcium, carbonate, bicarbonate, magnesium, phosphorus, potassium, and sodium salts, and mixtures thereof.

Optional nutritional components may also include vitamins, such as Vitamin A, Vitamin B (including B₁, B₂, B₃, B₅, B₆, B₇, B₉, and B₁₂), Vitamin C, Vitamin D, Vitamin E, Vitamin K, and mixtures thereof. Vitamin C is a preferred vitamin in some embodiments of the present technology. Optional nutritional components may also include minerals, such as calcium, phosphorus, potassium, sulfur, sodium, chlorine, and magnesium, as well as trace minerals such as iron, cobalt, copper, zinc, molybdenum, iodine, and selenium, and mixtures thereof.

Optional nutritional components may also include optional amino acids, comprising one or more naturally occurring amino acids other than isoleucine, leucine, lysine, methionine, phenylalanine, threonine, tryptophan, and valine (which may be present in the amino acid component, described above). Such optional amino acids include alanine, arginine, aspargine, aspartic acid, cysteine, histidine, glutamic acid, glutamine, glycine, proline, selenocysteine, serine, tyrosine, and combinations thereof. The optional amino acids may be present in elemental form, i.e., as substantially pure amino acids, or salts thereof, preferably comprising elemental L-amino acids. In some embodiments, however, the optional amino acids may comprise peptides or proteins comprising two, three, four, or more optional amino acids. Such optional peptides or proteins may additionally comprise one or more amino acids selected from the group consisting of isoleucine, leucine, lysine, methionine, phenylalanine, threonine, tryptophan, and valine. Thus, in some embodiments, the amino acid component may comprise a peptide or protein comprising one or more of isoleucine, leucine, lysine, methionine, phenylalanine, threonine, tryptophan, and valine, in addition to one or more optional amino acids.

### Methods

The present technology provides methods for improving the nutritional status of a human or other mammal, comprising administering a composition comprising a botanical component comprising one or more ginsenosides and an amino acid component, as described above. In addition to humans, mammals include companion animals and animals kept for sporting or commercial purposes, such as dogs, cats, and horses. Methods of the present technology include methods for improving the metabolism of the subject, improving nutrient absorption by the subject, improving physical performance of the subject, and improving glycogen metabolism of the subject.

In some embodiments, methods are for improving the nutritional or metabolic status of a human or mammalian subject incident to physical activity of the subject. For example, in some embodiments, methods increase the ability of the subject to adapt to stress or other environmental factors, such as incident to physical exercise.

Methods of the present technology may comprise administering a composition of the present technology before, during, or after physical exercise. Such exercise may be incident to work or recreation, such as participating in a sport. Methods may, for example, comprise one or more of methods for increasing endurance (such as endurance during high-intensity exercise), methods for promoting recovery after exercise, methods for attenuating muscle damage, methods for decreasing muscle soreness, methods for accelerating glycogen storage of exercised muscles (e.g., about 370% increase in muscle glycogen restoration during and after exercise), methods for decreasing sarcolemma lipid peroxidation, methods for improving absorption of amino acids (e.g, about 60% greater absorption of L-amino acids), methods for increasing net nitrogen utilization for protein synthesis, methods for improving glucose uptake and metabolism, methods for reducing digestion time, methods for increasing vitamin absorption, and methods for improving production of ATP (adenosine triphosphate, e.g., about 30% increase), methods for decreasing free radical damage after exercise (e.g., about 40% decrease), and methods for reducing creatine kinase synthesis after exercise (e.g., about 70% decrease).

Embodiments of the present technology are further illustrated through the following non-limiting examples.

### Example 1

A composition of the present technology is made containing the following components.

| Component | Amount in Unit Composition |
|---|---|
| L-Isoleucine | 1432 mg |
| L-Leucine | 1896 mg |
| L-Lysine | 1724 mg |
| L-Methionine | 675 mg |
| L-Phenylalanine | 1245 mg |
| L-Threonine | 1073 mg |
| L-Tryptophan | 355 mg |
| L-Valine | 1600 mg |
| AstraGin ™, Panax notoginseng extract | 50 mg |
| and Astragalus membranaceus extract | |
| ActiGin ™, Rosa roxburghii extract and | 50 mg |
| Panax notoginseng extract | |
| Stevia leaf extract | 60 mg |

The composition is made by admixing the components with maltodextrin, sucrose, fructose, citric acid, flavorants, disodium phosphate, malic acid, dipotassium phosphate, sodium chloride, medium chain triglycerides, and beta carotene. The composition is then mixed with water to make a 16 ounce beverage, and ingested by a human subject. The subject consumes the composition on a daily basis immediately prior to exercising, and experiences increased endurance during exercise and reduced muscle fatigue.

### Example 2

A liquid beverage composition of the present technology is made containing the following components.

| Component | Amount in Unit Composition | |
|---|---|---|
| L-Isoleucine | 716 | mg |
| L-Leucine | 948 | mg |
| L-Lysine | 862 | mg |
| L-Methionine | 337.5 | mg |
| L-Phenylalanine | 622.5 | mg |
| L-Threonine | 536.5 | mg |
| L-Tryptophan | 177.5 | mg |
| L-Valine | 800 | mg |
| AstraGin ™, Panax notoginseng extract | 50 | mg |
| and Astragalus membranaceus extract | | |
| ActiGin ™, Rosa roxburghii extract and | 50 | mg |
| Panax notoginseng extract | | |
| Stevia leaf extract | 60 | mg |
| Vitamin C (ascorbic acid) | 120 | mg |
| Calcium (tricalcium phosphate) | 100 | mg |
| Magnesium (magnesium citrate) | 50 | mg |
| Potassium (potassium citrate) | 85 | mg |

The composition is made by admixing the components with glycerin, flavorants, fructose, and preservatives. The final composition is then mixed with water to make a four ounce beverage. The resulting beverage composition contains 44 calories, 5 grams of carbohydrates, and 5 grams of sugars.

A human subject consumes the composition on a daily basis as part of a nutritional regimen, and experiences increased muscle building.

### Example 3

A powder composition of the present technology is made containing the following components.

| Component | Amount in Unit Composition | |
|---|---|---|
| L-Isoleucine | 716 | mg |
| L-Leucine | 948 | mg |
| L-Lysine | 862 | mg |
| L-Methionine | 337.5 | mg |
| L-Phenylalanine | 622.5 | mg |
| L-Threonine | 536.5 | mg |
| L-Tryptophan | 177.5 | mg |
| L-Valine | 800 | mg |
| AstraGin ™, Panax notoginseng extract | 50 | mg |
| and Astragalus membranaceus extract | | |
| ActiGin ™, Rosa roxburghii extract and | 50 | mg |
| Panax notoginseng extract | | |

The composition is made by admixing the components with maltodextrin, flavorants, stevia leaf extract, and silica. The final composition is then packaged as a unit dose in a stick-form pouch.

A human subject mixes the powder composition with water, making a 7.5 ounce beverage. The beverage is consumed immediately after an exercise routine, reducing muscle fatigue.

### Example 4

A liquid beverage composition of the present technology is made containing the following components.

| Component | Amount in Unit Composition | |
|---|---|---|
| L-Isoleucine | 286.4 | mg |
| L-Leucine | 379.2 | mg |
| L-Lysine | 344.8 | mg |
| L-Methionine | 135 | mg |
| L-Phenylalanine | 249 | mg |
| L-Threonine | 214.6 | mg |
| L-Tryptophan | 71 | mg |
| L-Valine | 320 | mg |
| AstraGin ™, Panax notoginseng extract | 50 | mg |
| and Astragalus membranaceus extract | | |
| ActiGin ™, Rosa roxburghii extract and | 50 | mg |
| Panax notoginseng extract | | |
| Vitamin C (ascorbic acid) | 120 | mg |
| Calcium (calcium carbonate) | 100 | mg |
| Magnesium (magnesium sulfate) | 50 | mg |
| Potassium (potassium acesulfame) | 85 | mg |

The composition is made by admixing the components with citric acid, polyethylene glycol, flavorants, cane sugar, and preservatives. The final composition is then mixed with water to make a 16 ounce beverage. The resulting beverage composition contains 21 grams of carbohydrates, and 21 grams of sugars.

A human subject consumes the composition on a daily basis as part of a nutritional regimen, and experiences decreased muscle fatigue.

### Non-Limiting Discussion of Terminology

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

All references cited in the Description section of this specification are hereby incorporated by reference in their entirety.

Unless stated otherwise, all compositional percentages are by weight of a nutritional composition.

The description and specific examples, while indicating embodiments of the technology, are intended for purposes of illustration only and are not intended to limit the scope of the technology. Equivalent changes, modifications and variations of specific embodiments, materials, compositions and methods may be made within the scope of the present technology, with substantially similar results. Moreover, recitation of multiple embodiments having stated features is not intended to exclude other embodiments having additional features, or other embodiments incorporating different combinations of the stated features. For example, a component which may be A, B, C, D or E, or combinations thereof, may also be defined, in some embodiments, to be A, B, C, or combinations thereof. Specific examples are provided for illustrative purposes of how to make and use the compositions and methods of this technology and, unless explicitly stated otherwise, are not intended to be a representation that given embodiments of this technology have, or have not, been made or tested.

As used herein, the words “prefer” or “preferable” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein. Further, as used herein the term “consisting essentially of” recited materials or components envisions embodiments “consisting of” the recited materials or components.

A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters.

As referred to herein, ranges are, unless specified otherwise, inclusive of endpoints and include disclosure of all distinct values and further divided ranges within the entire range. Thus, for example, a range of “from A to B” or “from about A to about B” is inclusive of A and of B. Further, the phrase “from about A to about B” includes variations in the values of A and B, which may be slightly less than A and slightly greater than B; the phrase may be read be “about A, from A to B, and about B.” Disclosure of values and ranges of values for specific parameters (such as temperatures, molecular weights, weight percentages, etc.) are not exclusive of other values and ranges of values useful herein.

It is also envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

What is claimed is:

1. A nutritional composition comprising:
(a) a botanical component comprising a ginsenoside; and
(b) an amino acid component comprising three amino acids selected from the group consisting of isoleucine, leucine, lysine, methionine, phenylalanine, threonine, tryptophan, and valine.

2. The nutritional composition of claim 1, wherein the botanical component is selected from the group consisting of a Panax extract, an Astragalus extract, a Rosa extract, fractions thereof, active components thereof, and combinations thereof.

3. The nutritional composition of claim 2, wherein the botanical is selected from the group consisting of a Panax notoginseng extract, an Astragalus membranaceus extract, a Rosa roxburghii extract, fractions thereof, active components thereof, and combinations thereof.

4. The nutritional composition of claim 3, comprising a Panax notoginseng extract, an Astragalus membranaceus extract, and a Rosa roxburghii extract.

5. The nutritional composition of claim 1, wherein the amino acid component comprises isoleucine, leucine, lysine, methionine, phenylalanine, threonine, tryptophan, and valine.

6. The nutritional composition of claim 1, further comprising an optional nutritional component selected from the group consisting of vitamins, minerals, electrolytes, optional amino acids, and mixtures thereof.

7. The nutritional composition of claim 1, wherein the composition is a powder or liquid.

8. A nutritional composition comprising:
(a) an adaptogenic botanical component comprising a botanical selected from the group consisting of a Panax notoginseng extract, an Astragalus membranaceus extract, a Rosa roxburghii extract, fractions thereof, active components thereof, and combinations thereof; and
(b) an amino acid component selected from the group consisting of isoleucine, leucine, lysine, methionine, phenylalanine, threonine, tryptophan, valine, and combinations thereof.

9. The nutritional composition of claim 8, wherein the amino acid component comprises two or more of isoleucine, leucine, lysine, methionine, phenylalanine, threonine, tryptophan, and valine.

10. The nutritional composition of claim 8, further comprising an additional adaptogenic botanical component.

11. The nutritional composition of claim 8, further comprising an optional nutritional component selected from the group consisting of vitamins, minerals, electrolytes, optional amino acids, and mixtures thereof.

12. A method for improving the physical endurance of a human or other mammalian subject, comprising administering to the subject a composition comprising:
(a) an adaptogenic botanical component comprising a botanical selected from the group consisting of a Panax extract, an Astragalus extract, a Rosa extract, fractions thereof, active components thereof, and combinations thereof; and
(b) an amino acid component selected from the group consisting of isoleucine, leucine, lysine, methionine, phenylalanine, threonine, tryptophan, valine, and combinations thereof.

13. The method of claim 12, wherein the adaptogenic botanical is selected from the group consisting of a Panax notoginseng extract, an Astragalus membranaceus extract, a Rosa roxburghii extract, fractions thereof, active components thereof, and combinations thereof.

14. The method of claim 13, wherein the adaptogenic botanical comprises a mixture of Panax notoginseng extract, an Astragalus membranaceus extract, and a Rosa roxburghii extract, or a fraction thereof.

15. The method of claim 13, further comprising an additional adaptogenic botanical component.

16. The method of claim 12, wherein the amino acid component comprises two or more of isoleucine, leucine, lysine, methionine, phenylalanine, threonine, tryptophan, and valine.

17. The method of claim 12, further comprising an optional nutritional component selected from the group consisting of vitamins, minerals, electrolytes, optional amino acids, and mixtures thereof.

18. The method of claim 12, wherein the composition is a powder or liquid.
